(19) United States
(12) Patent Application Publication
(10) Pub. No.: US 2015/0309649 A1
(43) Pub. Date: Oct. 29, 2015

(54) DISPLAY DRIVING INTEGRATED CIRCUIT, SYSTEM INCLUDING THE SAME AND DISPLAY DRIVING METHOD

(71) Applicant: SAMSUNG ELECTRONICS CO., LTD., Suwon-si (KR)

(72) Inventor: Jong-Oh LEE, Anyang-si (KR)

(73) Assignee: SAMSUNG ELECTRONICS CO., LTD., Suwon-si (KR)

(21) Appl. No.: 14/574,980

(22) Filed: Dec. 18, 2014

(30) Foreign Application Priority Data
Apr. 24, 2014 (KR) 10-2014-0049164

(51) Int. Cl. G06F 3/041

(52) U.S. Cl. CPC G06F 3/0416; G06F 3/0412

(57) ABSTRACT

A system includes an input-output unit, a system on chip, a touch integrated circuit and a display driving integrated circuit. The input-output unit includes a display panel configured to display images based on display data and a touch panel configured to provide touch data corresponding to a touch operation of a user. The system on chip includes a processor configured to generate graphic user interface (GUI) image data using a GUI engine. The touch integrated circuit generates touch coordinate data based on the touch data. The display driving integrated circuit generates the display data based on the GUI image data provided from the processor in a normal display mode and generates the display data based on the touch coordinate data provided from the touch integrated circuit in a fast display mode.

### CROSS-REFERENCE TO RELATED APPLICATIONS

This U.S. Non-provisional application claims priority under 35 USC §119 to Korean Patent Application No. 10-2014-0049164, filed on Apr. 24, 2014, in the Korean Intellectual Property Office (KIPO), the disclosure of which is incorporated by reference in its entirety herein.

### BACKGROUND OF THE INVENTION

1. Field of the Invention

Example embodiments relate generally to semiconductor integrated circuits, and more particularly to a display driving integrated circuit, a system including a display driving integrated circuit, and a display driving method for enhancing a touch response speed.

2. Description of the Related Art

Touch panels and touch screens are widely used in electronic devices to detect an input action or a touch operation by a user. The user may use fingers or stylus pens to touch the surface of the touch screen so that a desired function may be performed in the electronic device adopting the touch screen as one of the input means. Uses of the touch screen are expanding to various devices, particularly to mobile devices pursuing miniaturization, and the touch screen is replacing the input means such as a keyboard, a mouse, etc.

When the user performs the touch operation to write or draw using the touch panel or the touch screen, data processing for displaying images corresponding to the touch operation of the user may be delayed, and an operational speed and performance recognized by the user may be degraded.

### SUMMARY OF THE INVENTION

At least one example embodiment of the present disclosure provides a display driving integrated circuit for enhancing a touch response speed recognized by a user.

Additional features and utilities of the present invention will be set forth in part in the description which follows and, in part, will be obvious from the description, or may be learned by practice of the general inventive concept.

At least one example embodiment of the present disclosure provides a system including a display driving integrated circuit for enhancing a touch response speed recognized by a user.

At least one example embodiment of the present disclosure provides a display driving method for enhancing a touch response speed recognized by a user.

According to example embodiments, a system may include an input-output unit, a system on chip, a touch integrated circuit and a display driving integrated circuit. The input-output unit may include a display panel configured to display images based on display data and a touch panel configured to provide touch data corresponding to a touch operation of a user. The system on chip may include a processor configured to generate graphic user interface (GUI) image data using a GUI engine. The touch integrated circuit may generate touch coordinate data based on the touch data. The display driving integrated circuit may generate the display data based on the GUI image data provided from the processor in a normal display mode, and may also generate the display data based on the touch coordinate data provided from the touch integrated circuit in a fast display mode.

The display driving integrated circuit may, in the fast display mode, modify the display data based on the touch coordinate data regardless of processing of the GUI engine to display a touch image corresponding to the touch operation of the user on the display panel.

The processor may monitor operations of the system to generate a display mode signal indicating the normal display mode or the fast display mode.

The fast display mode may correspond to an operation mode while the user writes or draws on the touch panel.

In the fast display mode, the touch coordinate data may be transferred from the touch integrated circuit to the display driving integrated circuit through a direct transfer path connecting the touch integrated circuit and the display driving integrated circuit.

In the fast display mode, the touch coordinate data may be transferred from the touch integrated circuit to the display driving integrated circuit through an internal transfer path within the system on chip.

The display driving integrated circuit may include a frame memory configured to store the display data, a driving unit configured to drive the display panel based on the display data stored in the frame memory, a touch image generator configured to, in the fast display mode, generate modified display data representing a touch image corresponding to the touch operation of the user based on the display data stored in the frame memory and the touch coordinate data, and a controller configured to control operations of the frame memory, the driving unit and the touch image generator.

The controller may update the display data by storing the GUI image data provided from the processor in the frame memory in the normal display mode, and may also update the display data by storing the modified display data provided from the touch image generator in the frame memory in the fast display mode.

The display driving integrated circuit may further include a register configured to store set data of the touch image corresponding to the touch operation of the user.

The touch image generator may adjust at least one of a color and a width of the touch image based on the set data stored in the register.

The display driving integrated circuit may further include a first interface for exchanging signals with the system on chip, and a second interface for exchanging signals with the touch integrated circuit.

In the fast display mode, the touch coordinate data may be transferred directly from the touch integrated circuit to the display driving integrated circuit through the second interface.

Alternatively, the display driving integrated circuit may further include a first interface for exchanging signals with the system on chip, and the system on chip may further include an internal transfer path that is enabled in the fast display mode.

In the fast display mode, the touch coordinate data may be transferred from the touch integrated circuit to the system on chip and then transferred from the system on chip to the display driving integrated circuit through the internal transfer path and the first interface.

The touch image generator may include a mapping unit configured to generate display coordinate data corresponding to the touch image based on the touch coordinate data and width information, and a synthesizer configured to generate the modified display data representing the touch image based on the display data stored in the frame memory, the display coordinate data and color information.

The touch image generator further include a verification unit configured to compare the touch coordinate data with write region data representing a range of a write region on the touch panel in order to determine whether to generate the display coordinate data.

According to example embodiments, a display driving integrated circuit may generate display data for driving a display panel based on GUI image data provided from a processor in a normal display mode, and may also generate the display data based on touch coordinate data provided from a touch integrated circuit in a fast display mode.

The display driving integrated circuit may include a frame memory configured to store the display data, a driving unit configured to drive the display panel based on the display data stored in the frame memory, a touch image generator configured to, in the fast display mode, generate modified display data representing a touch image corresponding to a touch operation of a user based on the display data stored in the frame memory and the touch coordinate data, and a controller configured to control operations of the frame memory, the driving unit and the touch image generator.

The controller may update the display data by storing the GUI image data provided from the processor in the frame memory in the normal display mode, and may also update the display data by storing the modified display data provided from the touch image generator in the frame memory in the fast display mode.

According to example embodiments, a display driving method may include generating a display mode signal by monitoring operations of a system, when the display mode signal is activated, receiving touch coordinate data from a touch integrated circuit to generate display data for driving a display panel based on the touch coordinate data, and when the display mode signal is deactivated, receiving graphic user interface (GUI) image data from a processor to generate the display data based on the GUI image data.

### BRIEF DESCRIPTION OF THE DRAWINGS

These and/or other features and utilities of the present invention will become apparent and more readily appreciated from the following description of the embodiments, taken in conjunction with the accompanying drawings of which:

FIG. 1 is a block diagram illustrating a system according to example embodiments.

FIG. 2 is a block diagram illustrating a system including a data transfer path according an example embodiment.

FIG. 3 is a block diagram illustrating an example embodiment of a display driving integrated circuit included in the system of FIG. 2.

FIG. 4 is a block diagram illustrating an example embodiment of a touch integrated circuit included in the system of FIG. 2.

FIG. 5 is a block diagram illustrating a system including a data transfer path according an example embodiment.

FIG. 6 is a diagram illustrating an example embodiment of an interface of a system on chip included in the system of FIG. 5.

FIG. 7 is a block diagram illustrating an example embodiment of a display driving integrated circuit included in the system of FIG. 5.

FIG. 8 is a block diagram illustrating an example embodiment of a touch integrated circuit included in the system of FIG. 5.

FIG. 9 is a diagram illustrating an example frame image based on a graphic user interface (GUI) image data.

FIG. 10 is a diagram illustrating an example frame image including a pop-up window for inputting set data of a touch image corresponding to a touch operation of a user.

FIG. 11 is a block diagram illustrating an example embodiment of a touch image generator included in a display driving integrated circuit according to example embodiments.

FIG. 12 is a diagram illustrating an example frame image including a touch image corresponding to a touch operation of a user.

FIG. 13 is a diagram illustrating an example frame image including a pop-up window for selecting a background image.

FIG. 14 is a diagram illustrating an example frame image including a selected background image.

FIG. 15 is a diagram illustrating an example frame image including a selected background image and a touch image corresponding to a touch operation of a user.

FIG. 16 is a flow chart illustrating a display driving method according to example embodiments.

FIG. 17 is a block diagram illustrating a mobile device according to example embodiments.

FIG. 18 is a diagram illustrating an example in which the mobile device of FIG. 17 is implemented as a smart-phone.

### DETAILED DESCRIPTION OF THE PREFERRED EMBODIMENTS

Various example embodiments will be described more fully hereinafter with reference to the accompanying drawings, in which some example embodiments are shown. The present disclosure may, however, be embodied in many different forms and should not be construed as limited to the example embodiments set forth herein. Rather, these example embodiments are provided so that this disclosure will be thorough and complete, and will fully convey the scope of the present disclosure to those skilled in the art. In the drawings, the sizes and relative sizes of layers and regions may be exaggerated for clarity. Like numerals refer to like elements throughout. The embodiments are described below in order to explain the present invention while referring to the figures.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

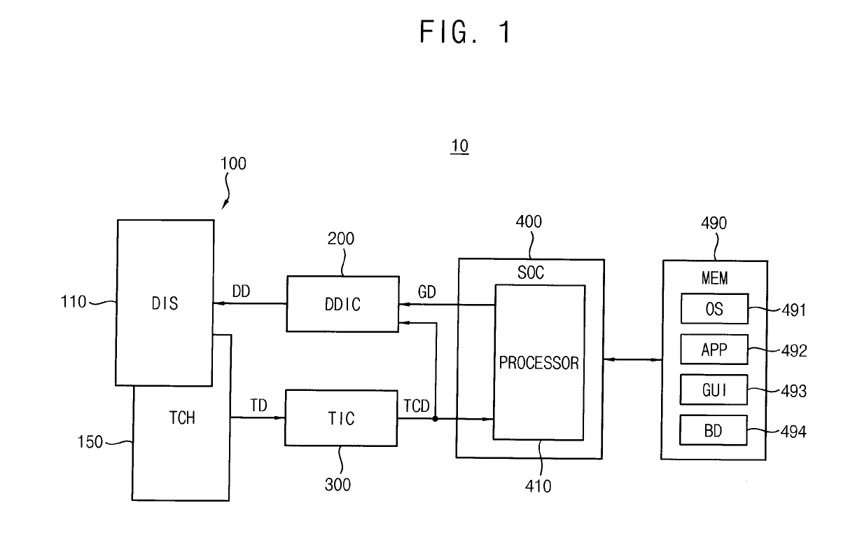

FIG. 1 is a block diagram illustrating a system according to example embodiments.

Referring to FIG. 1, a system 10 may include an input-output unit 100, a display driving integrated circuit DDIC 200, a touch integrated circuit TIC 300, a system on chip SOC 400 and a memory device MEM 490.

The input-output unit 100 may include a display panel DIS 110 configured to display images based on display data DD and a touch panel TCH 150 configured to provide touch data TD corresponding to a touch operation of a user. In some example embodiments, the display panel 110 and the touch panel 150 may form a touch screen. A touch screen may represent a single screen that includes a superimposed touch panel and a display panel. Even though not illustrated in FIG. 1, the system 10 may further include input means such as a keypad, a mouse, etc. and output means such as a printer, etc.

The display panel 110 may be implemented with a panel of various kinds configured to display images or pictures such as a liquid crystal display (LCD) panel, a light-emitting diode (LED) panel, an organic light-emitting diode (OLED) panel, etc. The touch panel 150 may include a plurality of panel points that are arranged in a matrix of a plurality of columns and a plurality of rows. Each position of the panel points on the touch panel 150 may be designated by (x, y) where x indicates a row coordinate and y indicates a column coordinate. The touch panel 150 may be configured to sense a plurality of touches performed by contacts on a plurality of panel points substantially at the same time. In other words, the touch panel 150 may be configured to output touch data TD representing contact intensity or touch intensity on the respective panel points. The touch data TD may be provided per a sensing period, that is, a frame period.

The system on chip 400 may include a processor 410 configured to generate graphic user interface (GUI) image data GD using a GUI engine. The GUI engine may be implemented as software, hardware, or a combination of software and hardware. Even though one processor 410 is illustrated in FIG. 1 for convenience of illustration, the system on chip 400 may be an application processor system on chip that includes a plurality of processors, processing units or computing units, or other components. For example, the plurality of components may include a power management unit, a memory controller, a central processing unit, a display controller, a file system block, a graphic processing unit, an image signal processor, a multi-format codec block, etc.

According to example embodiments, the processor 410 may be a main processor corresponding to the central processing unit, or a microprocessor configured to perform particular functions. The processor 410 may communicate with the memory device 490 through a bus and may communicate with an external device through a wire or wireless interface.

The touch integrated circuit 300 may generate touch coordinate data TCD based on the touch data TD. The touch integrated circuit 300 may control the operation of the touch panel 150, and may convert the touch data TD from the touch panel 150 to the touch coordinate data TCD in order to transfer the touch coordinate data TCD to the processor and/or the display driving integrated circuit 200. The touch coordinate data TCD may include coordinate values indicating locations of touch points. The touch coordinate data TCD may further include information on touch intensity, touch duration time, etc. depending on the kind of the touch panel 150. When the touch data TD from the touch panel 150 are analog signals, the touch integrated circuit 300 may include an analog font end, an analog-to-digital converter, etc. for converting the analog signals from the touch panel 150 to digital signals.

The display driving integrated circuit 200 may generate the display data DD based on the GUI image data GD provided from the processor 410 in a normal display mode. In contrast, the display driving integrated circuit 200 may generate the display data DD based on the touch coordinate data TCD provided from the touch integrated circuit 300 in a fast display mode. The fast display mode may correspond to an operation mode while the user writes or draws on the touch panel, and the touch image may correspond to characters or drawings.

The display driving integrated circuit 200 may, in the fast display mode, modify the display data DD based on the touch coordinate data TCD regardless of processing of the GUI engine in order to display a touch image corresponding to the touch operation of the user on the display panel 110. As such, the display driving integrated circuit 200 may, in the fast display mode, reduce data transfer path and data processing steps for generating the touch image corresponding to the touch operation of the user, and may enhance the touch response speed recognized by the user.

In some example embodiments, at least a portion of the display driving integrated circuit 200 and/or the touch integrated circuit 300 may be included in the system on chip 400. The memory device 490 may store data and program codes for the operations of the system 10. As illustrated in FIG. 1, the memory device 490 may store an operating system (OS) 491, an application (APP) 492, a GUI engine 493, buffered data 494, etc. For example, the memory device 490 may be implemented with a dynamic random access memory (DRAM), a mobile DRAM, a static random access memory (SRAM), a phase change random access memory (PRAM), a ferroelectric random access memory (FRAM), a resistance random access memory (RRAM) and/or a magnetic random access memory (MRAM).

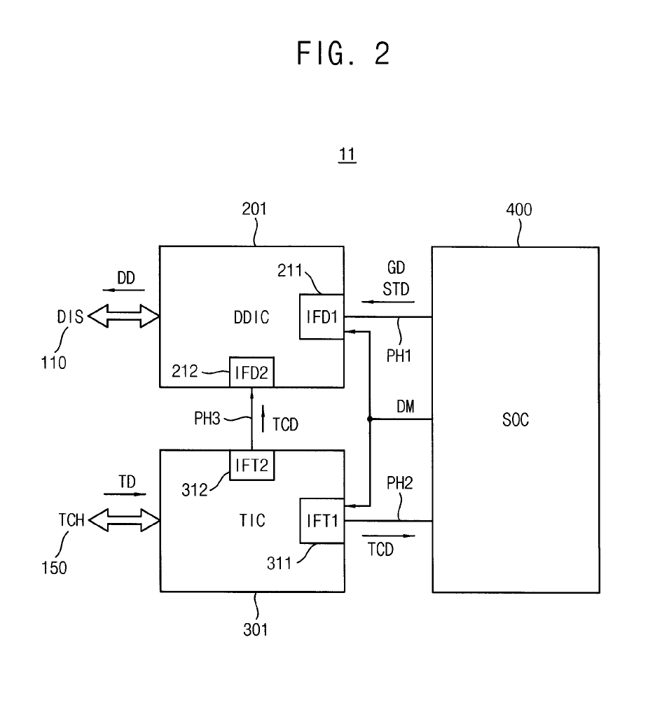

FIG. 2 is a block diagram illustrating a system including a data transfer path according an example embodiment.

Referring to FIG. 2, a system 11 may include an input-output unit (not shown) including a display panel DIS 110 and a touch panel TCH 150, a display driving integrated circuit DDIC 201, a touch integrated circuit TIC 301 and a system on chip SOC 400. FIG. 2 illustrates an example embodiment that, in the fast display mode, the touch coordinate data TCD may be transferred from the touch integrated circuit 301 to the display driving integrated circuit 201 through a direct transfer path PH3 connecting the touch integrated circuit 301 and the display driving integrated circuit 201.

As illustrated in FIG. 2, the display driving integrated circuit 201 may include a first interface IFD1 211 for exchanging signals with the system on chip 400 and a second interface IFD2 212 for exchanging signals with the touch integrated circuit 301. The touch integrated circuit 301 may include a third interface IFT1 311 for exchanging signals with the system on chip 400 and a fourth interface IFT2 312 for exchanging signals with the display driving integrated circuit 201. The first interface IFD1 211 of the display driving integrated circuit 201 may be connected to the system on chip 400 through a first transfer path PH1. The third interface IFT1 311 of the touch integrated circuit 301 may be connected to the system on chip 400 through a second transfer path PH2. The second interface IFD2 212 of the display driving integrated circuit 200 and the fourth interface IFT2 312 of the touch integrated circuit 301 may be connected to each other through a third transfer path PH3, that is, a direct transfer path.

The processor 410 in the system on chip 400 may monitor operations of the system 11 to generate a display mode signal DM indicating the normal display mode or the fast display mode. For example, a first logic level of the display mode signal DM may indicate the normal display mode, and a second logic level of the display mode signal DM may indicate the fast display mode. For example, the processor 410 may activate the display mode signal DM in the second logic level to launch the system 11 into the fast display mode when a memo application, a drawing board application, etc. is executed and the user is ready to input characters and/or drawings through the touch panel TCH.

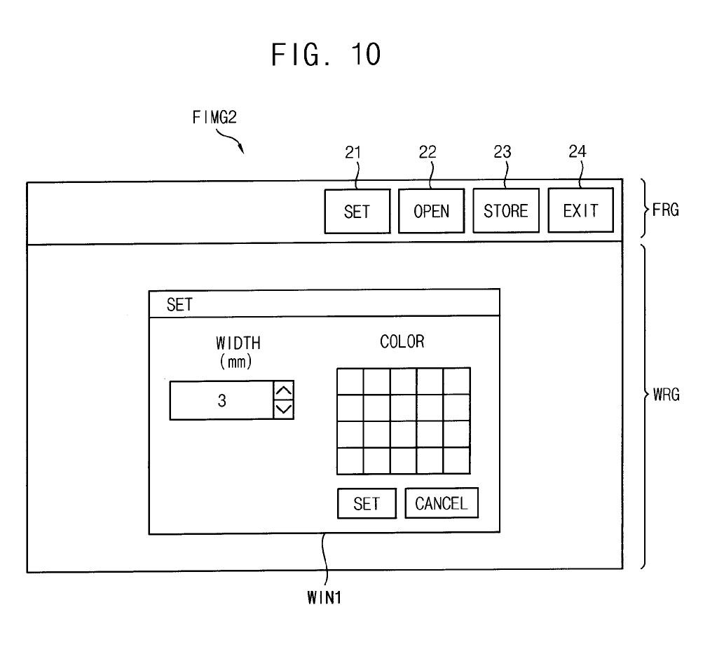

When the display mode signal DM indicates the normal display mode, the touch coordinate data TCD may be transferred from the touch integrated circuit 301 to the system on chip 400 through the second transfer path PH2 connected to the third interface IFT1 311. The GUI image data GD and set data STD may be transferred from the system on chip 400 to the display driving integrated circuit 201 through the first transfer path PH1 connected to the first interface IFD1 211. As described above, the GUI image data GD may be generated by the processor 410 using the GUI engine. The set data STD may include data for setting a color, a width, etc. of the touch image corresponding to the touch operation of the user, as described with reference to FIG. 10.

When the display mode signal DM indicates the fast display mode, the touch coordinate data TCD may be transferred directly from the touch integrated circuit 301 to the display driving integrated circuit 201 through the direct transfer path PH3 connecting the second interface IFD2 212 and the fourth interface IFT2 312. The display driving integrated circuit 201 may modify the display data DD based on the touch coordinate data TCD in order to display the touch image on the display panel DIS 110. Also in the fast display mode, the touch coordinate data TCD may be transferred from the touch integrated circuit 301 to the processor 410 in the system on chip 400 through the second transfer path PH2 connected to the third interface IFT1 311. The processor 410 may generate additional data corresponding to the touch image based on the touch coordinate data TCD. The touch image data generated by the processor 410 may not be transferred to the display driving integrated circuit 201.

As such, the touch coordinate data TCD may be transferred to the display driving integrated circuit 201 using the direct transfer path PH3 in the fast display mode, data transfer path and data processing steps for generating the touch image corresponding to the touch operation of the user may be reduced, and the touch response speed recognized by the user may be enhanced.

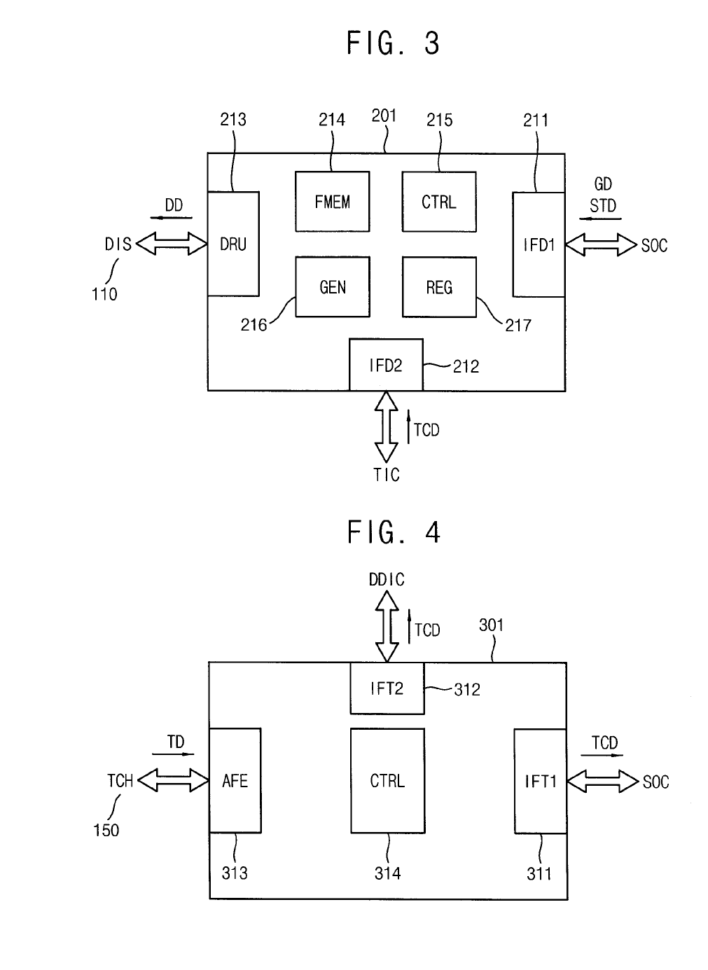

FIG. 3 is a block diagram illustrating an example embodiment of a display driving integrated circuit included in the system of FIG. 2, and FIG. 4 is a block diagram illustrating an example embodiment of a touch integrated circuit included in the system of FIG. 2.

Referring to FIG. 3, a display driving integrated circuit 201 may include a frame memory FMEM 214, a driving unit DRU 213, a tough image generator GEN 216, a register REG 217, a controller CTRL 215, a first interface IFD1 211, and a second interface IFD2 212.

The frame memory FMEM 214 may store the display data DD, and the driving unit DRU 213 may drive the display panel DIS 110 based on the display data DD stored in the frame memory FMEM 214.

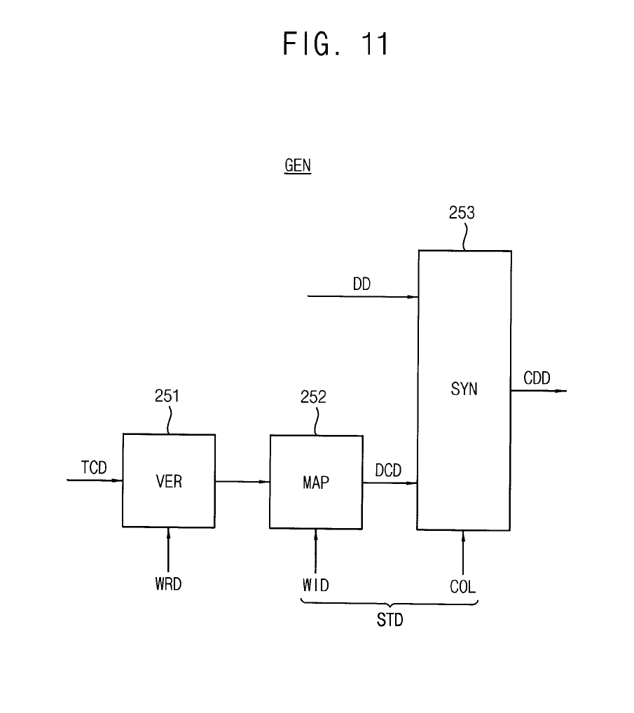

As will be described with reference to FIG. 11, the touch image generator GEN 216 may, in the fast display mode, generate modified display data representing a touch image corresponding to the touch operation of the user based on the display data DD stored in the frame memory FMEM 214 and the touch coordinate data TCD.

The register REG 217 may store set data STD of the touch image corresponding to the touch operation of the user. The touch image generator GEN 216 may adjust at least one of a color and a width of the touch image based on the set data STD stored in the register REG 217. The set data STD may be provided as predetermined default values and the set data STD may be updated by the user.

The first interface IFD1 211 may mediate communication between the display driving integrated circuit 201 and the system on chip SOC 400, and the second interface IFD2 212 may mediate communication between the display driving integrated circuit 201 and the touch integrated circuit TIC 301. The controller CTRL 215 may control operations of the frame memory FMEM 214, the driving unit DRU 213, the touch image generator GEN 216, the register REG 217, and the interfaces IFD1 211 and IFD2 212.

The display driving integrated circuit 201 may receive the GUI image data GD and the set data STD through the first interface IFD1 211 in the normal display mode, and may receive the touch coordinate data TCD through the second interface IFD2 212 in the fast display mode.

In the normal display mode, the controller CTRL 215 may update the display data DD by storing the GUI image data GD provided from the processor 410 of FIG. 1 in the frame memory FMEM 214. In contrast, in the fast display mode, the controller CTRL 215 may update the display data DD by storing the modified display data provided from the touch image generator GEN 216 in the frame memory FMEM 214.

Referring to FIG. 4, the touch integrated circuit TIC 301 may include an analog front end AFE 313, a controller CTRL 314, a third interface IFT1 311, and a fourth interface IFT2 312.

The analog front end AFE 313 may convert the touch data TD from analog signals to digital signals, and may generate the touch coordinate data TCD based on the digital signals.

The third interface IFT1 311 may mediate communication between the touch integrated circuit 301 and the system on chip SOC 400, and the fourth interface IFT2 312 may mediate communication between the touch integrated circuit 301 and the display driving integrated circuit DDIC 201. The controller CTRL 314 may control operations of the analog front end AFE 313 and the interfaces IFT1 311 and IFT2 312.

In the normal display mode, the controller CTRL 314 may enable the third interface IFT1 311 and disable the fourth interface IFT2 312 in order to provide the touch coordinate data TCD to the system on chip SOC 400. In contrast, in the fast display mode, the controller CTRL 314 may enable both of the third and fourth interfaces IFT1 311 and IFT2 312 in order to provide the touch coordinate data TCD to the display driving integrated circuit DDIC 201 and the system on chip SOC 400.

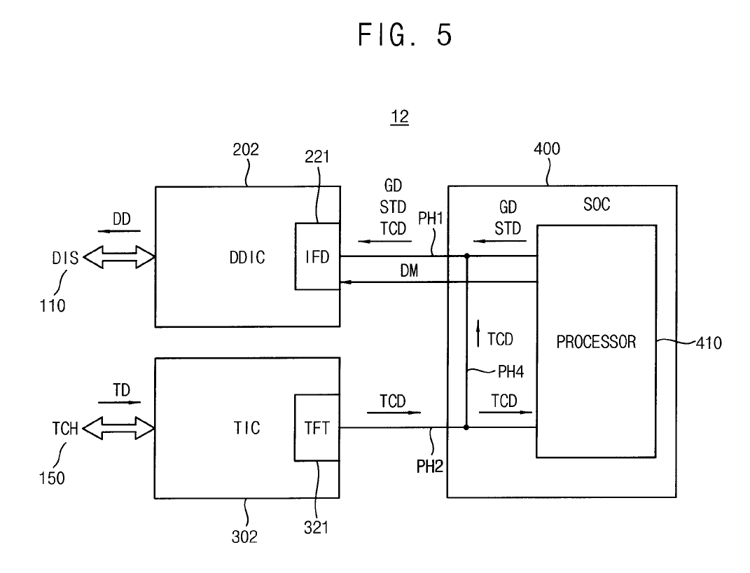

FIG. 5 is a block diagram illustrating a system including a data transfer path according an example embodiment.

Referring to FIG. 5, a system 12 may include an input-output unit (not shown) including a display panel DIS 110 and a touch panel TCH 150, a display driving integrated circuit DDIC 202, a touch integrated circuit TIC 302 and a system on chip SOC 400. FIG. 5 illustrates an example embodiment that, in the fast display mode, the touch coordinate data TCD may be transferred from the touch integrated circuit 302 to the display driving integrated circuit 202 through an internal transfer path PH4 within the system on chip 400.

As illustrated in FIG. 5, the display driving integrated circuit 202 may include a first interface IFD 221 for exchanging signals with the system on chip 400, and the touch integrated circuit 302 may include a second interface IFT 321 for exchanging signals with the system on chip 400. The first interface IFD 221 of the display driving integrated circuit 202 may be connected to the system on chip 400 through a first transfer path PH1, and the second interface IFT 321 of the touch integrated circuit 302 may be connected to the system on chip 400 through a second transfer path PH2.

The processor 410 in the system on chip 400 may monitor operations of the system 12 to generate a display mode signal DM indicating the normal display mode or the fast display mode. For example, a first logic level of the display mode signal DM may indicate the normal display mode, and a second logic level of the display mode signal DM may indicate the fast display mode. For example, the processor 410 may activate the display mode signal DM in the second logic level to launch the system 11 into the fast display mode when a memo application, a drawing board application, etc. is executed and the user is ready to input characters and/or drawings through the touch panel TCH.

As illustrated in FIG. 5, the system on chip 400 may further include the internal transfer path PH4. The touch coordinate data TCD may be transferred from the touch integrated circuit 302 to the system on chip 400 through the second transfer path PH2 connected to the second interface IFT 321, regardless of the display mode.

When the display mode signal DM indicates the normal display mode, the internal transfer path PH4 may be disabled and the touch coordinate data TCD may be transferred to the processor 410. The GUI image data GD and set data STD may be transferred from the system on chip 400 to the display driving integrated circuit 202 through the first transfer path PH1 connected to the first interface IFD 221. As described above, the GUI image data GD may be generated by the processor 410 using the GUI engine. The set data STD may include data for setting a color, a width, etc. of the touch image corresponding to the touch operation of the user, as described with reference to FIG. 10.

When the display mode signal DM indicates the fast display mode, the internal transfer path PH4 may be enabled and the touch coordinate data TCD may be transferred from the processor to the display driving integrated circuit 202 through the internal transfer path and the first transfer path connected to the first interface IFD 221. The display driving integrated circuit 201 may modify the display data DD based on the touch coordinate data TCD in order to display the touch image on the display panel DIS 110. Also in the fast display mode, the touch coordinate data TCD may be transferred to the processor 410 in the system on chip 400. The processor 410 may generate additional data corresponding to a touch image based on the touch coordinate data TCD. The additional data corresponding to the touch image generated by the processor 410 may not be transferred to the display driving integrated circuit 201.

As such, the touch coordinate data TCD may be transferred to the display driving integrated circuit 201 using the internal transfer path PH4 in the fast display mode, and the data transfer path and data processing steps for generating the touch image corresponding to the touch operation of the user may be reduced, and the touch response speed recognized by the user may be enhanced.

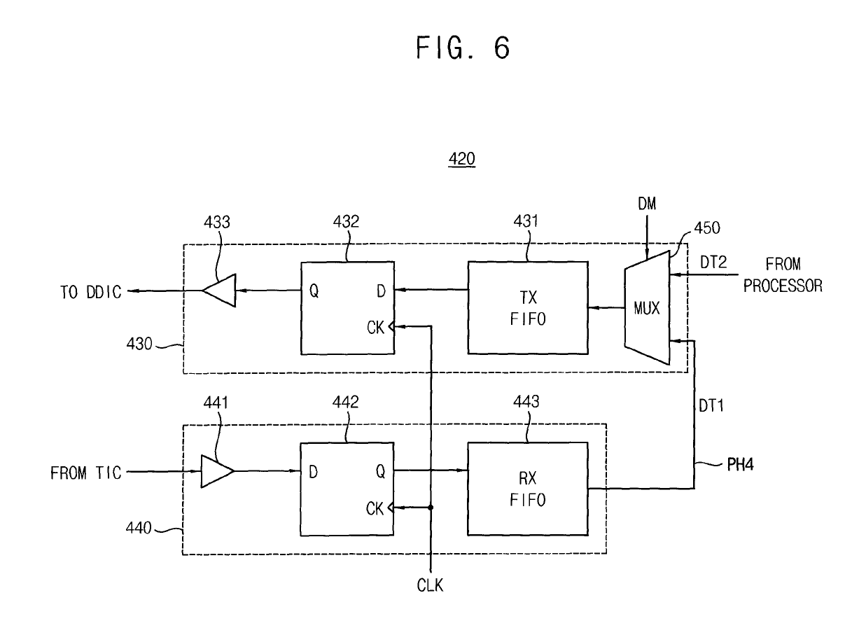

FIG. 6 is a diagram illustrating an example embodiment of an interface of a system on chip included in the system of FIG. 5.

Referring to FIG. 6, an interface 420 of the system on chip 400 may include a transmission block 430 and a reception block 440. The transmission block 430 may include a transmission driver 433, a flip-flop 432, a transmission memory TX FIFO 431 and a selector MUX 450. The reception block 440 may include a reception buffer 441, a flip-flop 442 and a reception memory RX FIFO 443. The flip-flops 432 and 442 may be configured to synchronize transmission and reception timings of signals to a clock signal CLK. The transmission and reception memories 431 and 443 may be implemented as first-in first-out buffers.

The selector 450 may select and output one of first data DT1 from the reception memory 443 and second data DT2 from the processor in response to the display mode signal DM. The selector 450 may select and output the second data DT2 from the processor when the display mode signal DM indicates the normal display mode. The selector 450 may select and output the first data DT1 from the reception memory 443 when the display mode signal DM indicates the fast display mode. As a result, the internal transfer path PH4 may be disabled in the normal display mode, and the internal transfer path PH4 may be enabled in the fast display mode. As such, the touch coordinate data TCD, which is transferred from the touch integrated circuit TIC to the reception block 440, may bypass the internal transfer path PH4, and then may be transferred from the transmission block 430 to the display driving integrated circuit DDIC.

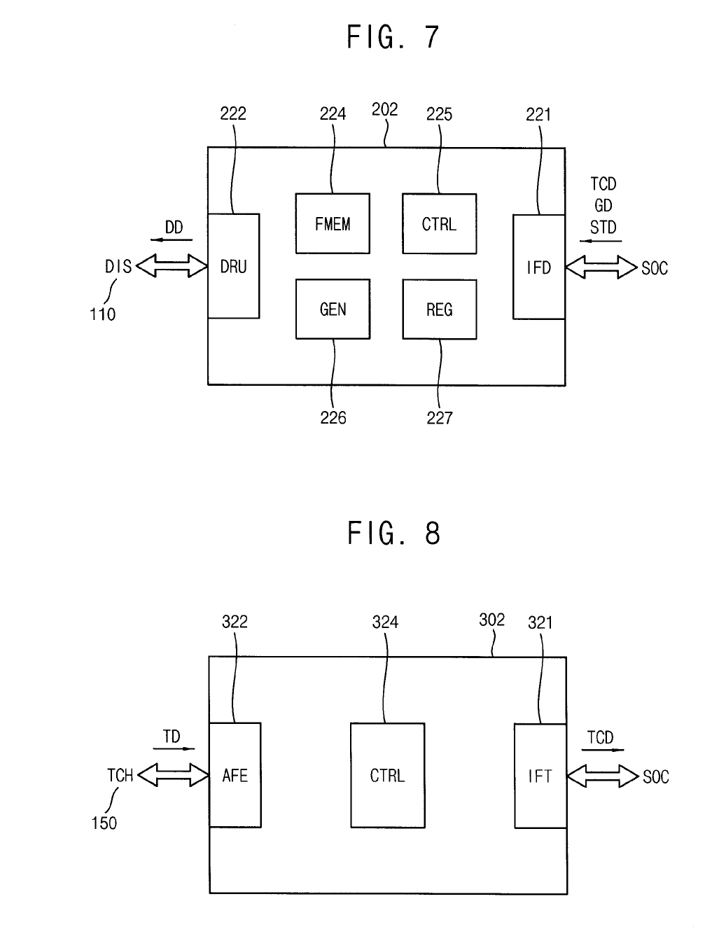

FIG. 7 is a block diagram illustrating an example embodiment of a display driving integrated circuit included in the system of FIG. 5, and FIG. 8 is a block diagram illustrating an example embodiment of a touch integrated circuit included in the system of FIG. 5.

Referring to FIG. 7, a display driving integrated circuit 202 may include a frame memory FMEM 224, a driving unit DRU 222, a tough image generator GEN 226, a register REG 227, a controller CTRL 225, and a first interface IFD 221.

The frame memory FMEM 224 may store the display data DD, and the driving unit DRU 222 may drive the display panel DIS 110 based on the display data DD stored in the frame memory FMEM 224.

As will be described with reference to FIG. 11, the touch image generator GEN 226 may, in the fast display mode, generate modified display data representing a touch image corresponding to the touch operation of the user based on the display data DD stored in the frame memory FMEM 224 and the touch coordinate data TCD.

The register REG 227 may store set data STD of the touch image corresponding to the touch operation of the user. The touch image generator GEN 226 may adjust at least one of a color and a width of the touch image based on the set data STD stored in the register REG 227. The set data STD may be provided as predetermined default values and the set data STD may be updated by the user.

The first interface IFD 221 may mediate communication between the display driving integrated circuit 202 and the system on chip SOC 400. The controller CTRL 225 may control operations of the frame memory FMEM 224, the driving unit DRU 222, the touch image generator GEN 226, the register REG 227, and the first interface IFD 221.

The display driving integrated circuit 202 may receive the GUI image data GD and the set data STD through the first interface IFD 221 in the normal display mode, and may receive the touch coordinate data TCD through the first interface IFD 221 in the fast display mode.

In the normal display mode, the controller CTRL 225 may update the display data DD by storing the GUI image data GD provided from the processor 410 of FIG. 1 in the frame memory FMEM 224. In contrast, in the fast display mode, the controller CTRL 225 may update the display data DD by storing the modified display data provided from the touch image generator GEN 226 in the frame memory FMEM 224.

Referring to FIG. 8, a touch integrated circuit 302 may include an analog front end AFE 322, a controller CTRL 324, and a second interface IFT 321.

The analog front end AFE 322 may convert the touch data TD provided as analog signals to digital signals, and may generate the touch coordinate data TCD based on the digital signals.

The second interface IFT 321 may mediate communication between the touch integrated circuit 302 and the system on chip SOC 400. The controller CTRL 324 may control operations of the analog front end AFE 322 and the second interface IFT 321.

In the normal and fast display modes, the controller CTRL 324 may transfer the touch coordinate data TCD to the system on chip SOC 400 through the second interface IFT 321. In other words, the touch integrated circuit 301 may operate regardless of the display mode, and the display mode signal DM from the processor 410 may not be provided to the touch integrated circuit 302.

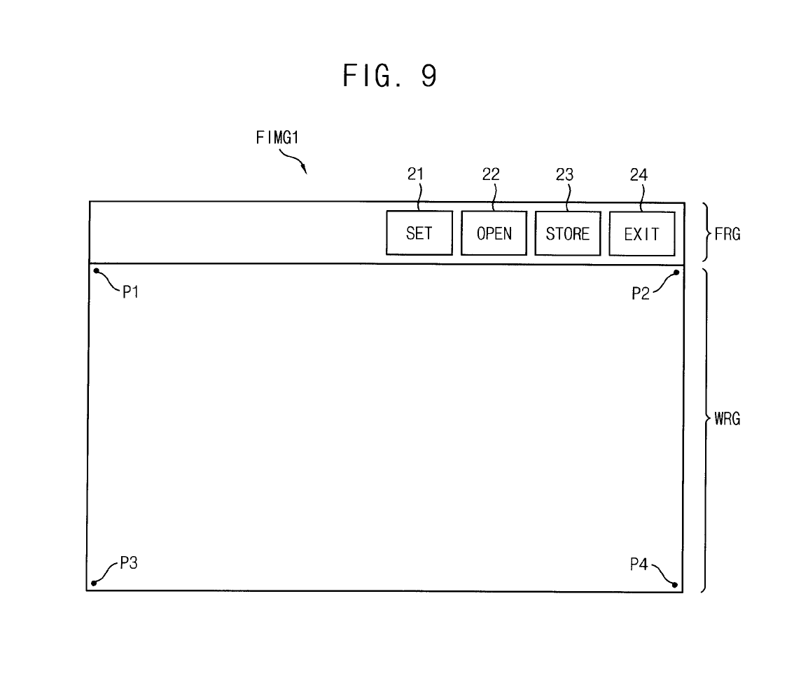

FIG. 9 is a diagram illustrating an example frame image based on a graphic user interface (GUI) image data.

For example, the frame image FIMG1 in FIG. 9 may be an initial frame image when a memo application is executed. When the memo application begins, the processor 410 in the system on chip 400 may perform the GUI engine to generate the GUI image data GD corresponding to the initial frame image and may provide the GUI image data GD to the display driving integrated circuit DDIC in order to display the frame image FIMG1 as illustrated in FIG. 9. The frame image FIMG1 may correspond to a state that the user is ready to input a touch image, and the processor 410 may activate the display mode to launch the system into the fast display mode.

Referring to FIG. 9, the frame image FIMG1 may include a function region FRG and a write region WRG. The function region FRG may be a region for the user to select a function that is provided by the memo application, and the write region WRG may be a region for the user to input a touch image.

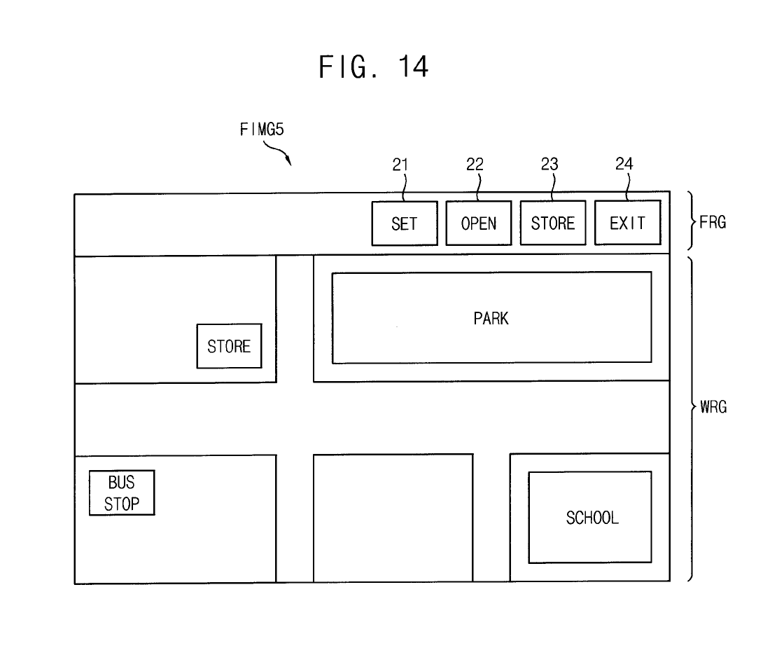

One or more icons or function buttons 21˜24 may be displayed in the function region FRG. For example, a pop-up window WIN1 as illustrated in FIG. 10 may be displayed when a set button 21 is touched, and a pop-up window WIN2 as illustrated in FIG. 13 may be displayed when an open button 22 is touched. The processes for storing a present image in the write region WRG may be performed when a store button 23 is touched, and the processes for finishing the memo application may be performed when an exit button 24 is touched.

In an example embodiment, the write region WRG may be defined by coordinates of four corner points P1˜P4. The coordinates of the points P1˜P4 may be provided as write region data to a touch image generator GEN as illustrated in FIG. 11. The touch image generator GEN may control its operation such that the touch image corresponding to the touch operation of the user may be limited within the write region WRG.

FIG. 10 is a diagram illustrating an example frame image including a pop-up window for inputting set data of a touch image corresponding to a touch operation of a user.

For example, a frame image FIMG2 including a pop-up window WIN1 as illustrated in FIG. 10 may be displayed when the user touches the set button 21. When the set button 21 is touched, the processor 410 may determine that the user is not ready to input a touch image, and thus may deactivate the display mode signal DM to launch the system into the normal display mode. The processor 410 may perform the GUI engine in order to generate the GUI image data GD corresponding to the frame image for receiving the set data from the user, and may provide the GUI image data GD to the display driving integrated circuit DDIC in order to display the frame image FIMG2 as illustrated in FIG. 10. The user may set a width, a color, etc. of a touch image through the GUI as illustrated in FIG. 10, and the input set data may be provided to the display driving integrated circuit DDIC to be stored in the above-described register REG.

FIG. 11 is a block diagram illustrating an example embodiment of a touch image generator included in a display driving integrated circuit according to example embodiments.

Referring to FIG. 11, a touch image generator GEN may include a verification unit VER 251, a mapping unit MAP 252 and a synthesizer SYN 253.

The verification unit 251 may compare the touch coordinate data TCD with the write region data WRD representing the range of the write region WRG on the touch panel as described with reference to FIG. 9 in order to determine whether to generate display coordinate data DCD. The verification unit 251 may control the operation of the touch image generator GEN based on the write region data WRD such that the touch image corresponding to the touch operation of the user may be limited within the write region WRG. The write region data WRD may be provided by the processor 410, and may be stored in the register REG in the display driving integrated circuit DDIC. For example, the touch location indicated by the touch coordinate data TCD may be out of the write region WRG, and the verification unit 251 may block the invalid touch coordinate data TCD from being transferred to the mapping unit 252. The verification unit 252 may be omitted when the write region WRG corresponds to the entire frame.

The mapping unit 252 may generate display coordinate data DCD corresponding to the touch image based on the touch coordinate data TCD and width information WID. When the resolution of the touch panel TCH is different from the resolution of the display panel DIS, the mapping unit 252 may extract the display points on the display panel DIS corresponding to the touch points on the touch panel TCH, and may generate the display coordinate data DCD including the display points and neighboring points within the range corresponding to the width information WID. The width information WID may be included in the above-described set data STD.

The synthesizer 252 may generate the modified display data CDD representing the touch image based on the display data DD stored in the frame memory FMEM, the display coordinate data DCD and color information COL. As described above, the controller CTRL of the display driving integrated circuit DDIC may update the display data DD by storing the modified display data CDD provided from the touch image generator GEN in the frame memory FMEM. The color information COL may be included in the above-described set data STD.

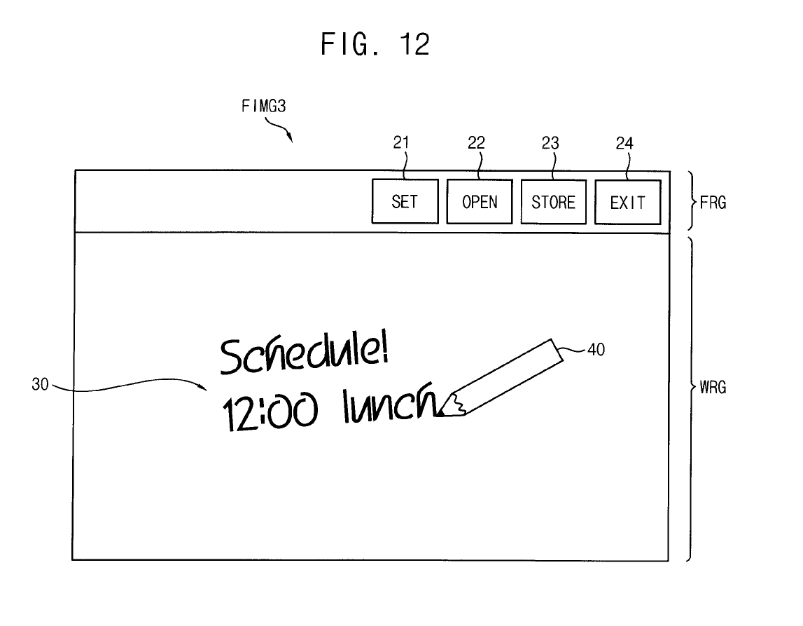

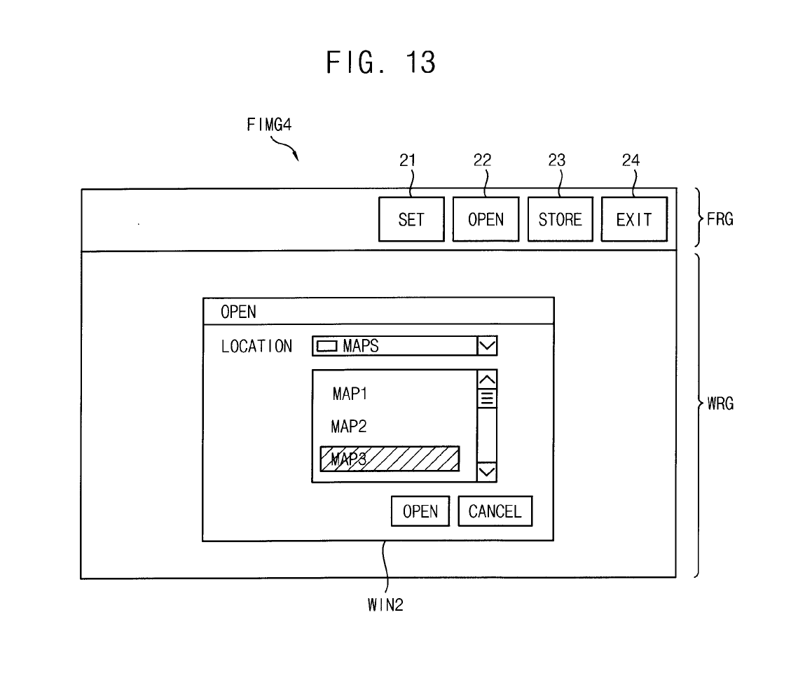

FIG. 12 is a diagram illustrating an example frame image including a touch image corresponding to a touch operation of a user.

The user may input touch images such as characters and drawings in the write region WRG using a finger, a stylus pen 40, etc. FIG. 12 illustrates a frame image FIMG3 including a touch image 30 corresponding to the touch operation or the write operation of the user.

The frame image FIMG3 in FIG. 12 may correspond to the touch image 30 on the frame image FIMG1 in FIG. 9. The touch coordinate data TCD may be provided periodically, and thus the display data DD in the frame memory FMEM may be updated periodically.

The display driving integrated circuit according to example embodiments may, in the fast display mode, modify the display data DD based on the touch coordinate data TCD regardless of processing of the GUI engine in order to display a touch image corresponding to the touch operation of the user on the display panel DIS. As such, the display driving integrated circuit may, in the fast display mode, reduce data transfer path and data processing steps for generating the touch image corresponding to the touch operation of the user, and may enhance the touch response speed recognized by the user.

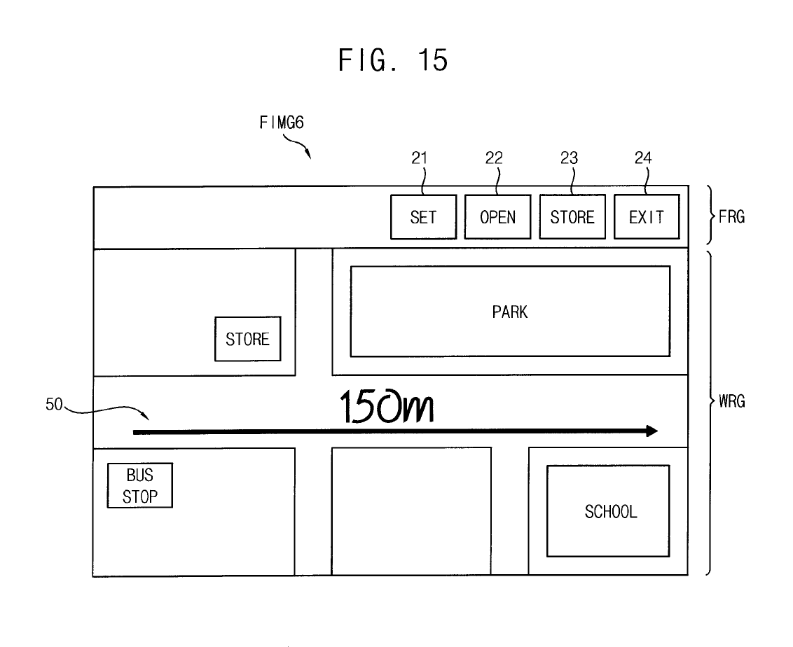

FIG. 13 is a diagram illustrating an example frame image including a pop-up window for selecting a background image, FIG. 14 is a diagram illustrating an example frame image including a selected background image, and FIG. 15 is a diagram illustrating an example frame image including a selected background image and a touch image corresponding to a touch operation of a user.

For example, a frame image FIMG4 including a pop-up window WIN2 as illustrated in FIG. 13 may be displayed when the user touches the open button 22. When the open button 22 is touched, the processor 410 may determine that the user is not ready to input a touch image, and thus may deactivate the display mode signal DM to launch the system into the normal display mode. The processor 410 may perform the GUI engine in order to generate the GUI image data GD corresponding to the frame image for selecting the background image by the user, and may provide the GUI image data GD to the display driving integrated circuit DDIC in order to display the frame image FIMG4 as illustrated in FIG. 13. The user may select the background image through the GUI as illustrated in FIG. 13 and the frame image FIMG5 including the selected background image as illustrated in FIG. 14.

The user may perform a touch operation on the displayed background image to modify the frame image. The frame image FIMG 6 in FIG. 15 is the result that the touch image 50 is overwritten on the frame image FIMG5 in FIG. 14.

The user may touch the store button 23 to store the modified image in the write region WRG in FIG. 15. For example, when the store button is touched, the processor may deactivate the display mode signal in order to enter the normal display mode, and may provide the GUI image data including a pop-up window for receiving a file name of the modified image.

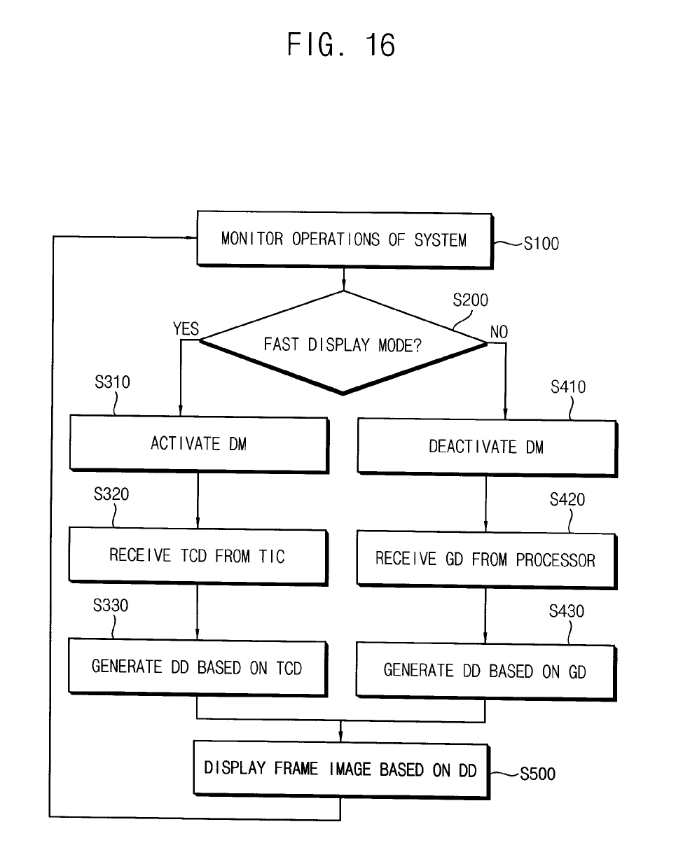

FIG. 16 is a flow chart illustrating a display driving method according to example embodiments.

Referring to FIGS. 1, 2, 5 and 16, the processor 410 may monitor operations of the system 10 (S100) to generate the display mode signal DM. When the processor 410 determines to enter the fast display mode (S200: YES), the processor 410 may activate the display mode signal DM (S310). When the processor 410 determines to enter the normal display mode (S200: NO), the processor 410 may deactivate the display mode signal DM (S410).

When the display mode signal DM is activated, the display driving integrated circuit DDIC may receive the touch coordinate data TCD from the touch integrated circuit TCD (S320), and may generate the display data DD for driving the display panel DIS based on the touch coordinate data TCD (S330).

When the display mode signal DM is deactivated, the display driving integrated circuit DDIC may receive the GUI image data GD from the processor 410 (S420), and may generate the display data DD for driving the display panel DIS based on the GUI display data GD (S430).

The display panel may display the frame image corresponding to the display data DD (S500).

As such, in the fast display mode, the data transfer path and the data processing steps for generating the touch image corresponding to the touch operation of the user may be reduced, and thus the touch response speed recognized by the user may be enhanced.

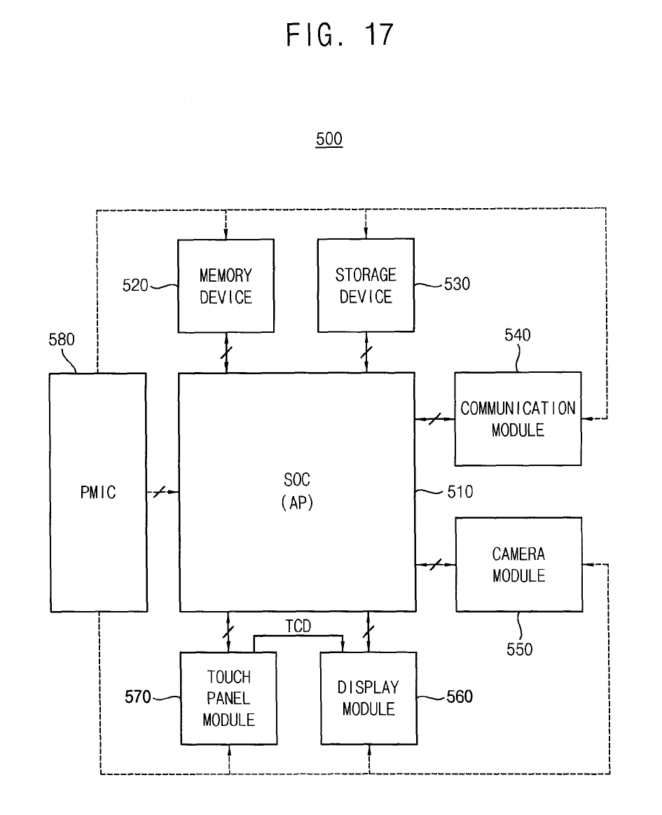

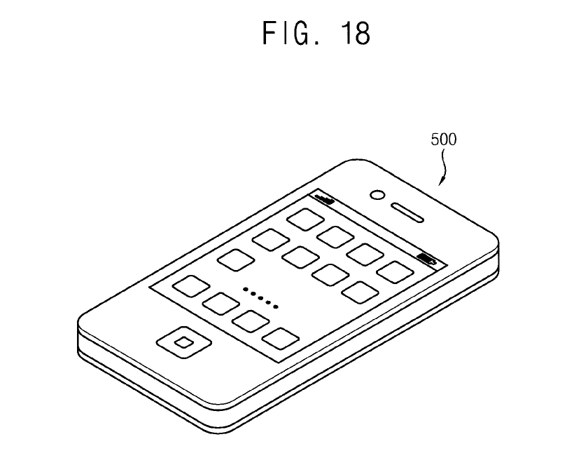

FIG. 17 is a block diagram illustrating a mobile device according to example embodiments, and FIG. 18 is a diagram illustrating an example in which the mobile device of FIG. 17 is implemented as a smart-phone.

Referring to FIGS. 17 and 18, a mobile device 500 may include a system on-chip 510, a memory device 520, a storage device 530, a plurality of function modules 540, 550, 560, and 570, and a power management integrated circuit 580. The power management integrated circuit 580 may provide an operating voltage to the system on-chip 510, the memory device 520, the storage device 530, and the function modules 540, 550, 560, and 570, respectively. As illustrated in FIG. 18, the mobile device 500 may be implemented as a smart-phone, and the system on-chip 510 may correspond to an application processor (AP). Although it is illustrated in FIG. 17 that the power management integrated circuit 580 is disposed outside the system on-chip 510, the power management integrated circuit 580 may be placed inside the system on-chip 510. The power management integrated circuit 580 may be referred to as a voltage control unit.

The application processor 510 (i.e., the system on chip SOC 510) may control an overall operation of the mobile device 500. That is, the application processor 510 may control the memory device 520, the storage device 530, and the function modules 540, 550, 560, and 570. Here, the application processor 510 may monitor an operating state or an operating condition of a central processing unit (CPU) included in the application processor 510, and may perform a dynamic voltage and frequency scaling (DVFS) (i.e., increase, decrease, or maintain an operating frequency of the central processing unit) based on the monitored operating condition of the central processing unit. In example embodiments, the DVFS may be performed by hardware or software.

The memory device 520 and the storage device 530 may store data for operations of the mobile device 500. In some example embodiments, the memory device 520 and the storage device 530 may be included in the application processor 510. For example, the memory device 520 may include a volatile semiconductor memory device such as a dynamic random access memory (DRAM) device, a static random access memory (SRAM) device, a mobile DRAM, etc. In addition, the storage device 530 may include a non-volatile semiconductor memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. In some example embodiments, the storage device 530 may further include a solid state drive (SSD), a hard disk drive (HDD), a CD-ROM, etc. However, kinds of the memory device 520 and the storage device 530 are not limited thereto.

The function modules 540, 550, 560, and 570 may perform various functions of the mobile device 500. For example, the mobile device 500 may include a communication module 540 that performs a communication function (e.g., a code division multiple access (CDMA) module, a long term evolution (LTE) module, a radio frequency (RF) module, an ultra wideband (UWB) module, a wireless local area network (WLAN) module, a worldwide interoperability for microwave access (WIMAX) module, etc.), a camera module 550 that performs a camera function, a display module 560 that performs a display function, a touch panel module 570 that performs a touch-input sensing function, etc. The display module 560 may include the above-described display driving integrated circuit DDIC. The touch panel module 570 may include the above-described touch integrated circuit TIC. According to example embodiments, the touch coordinate data TCD may be transferred from the touch panel module 570 to the display module 560 regardless of the GUI engine executed by the system on chip 510 in the fast display mode.

In some example embodiments, the mobile device 500 may further include a global positioning system (GPS) module, a microphone (MIC) module, a speaker module, various sensor modules (e.g., a gyroscope sensor, a geomagnetic sensor, an acceleration sensor, a gravity sensor, an illumination sensor, a proximity sensor, a digital compass, etc.). However, kinds of the function modules 540, 550, 560, and 570 included in the mobile device 500 are not limited thereto.

The elements illustrated in FIG. 17 may be implemented with various packaging schemes. For example, at least some elements may be implemented using Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), etc.

Although it is illustrated in FIGS. 17 and 18 that the system on-chip 510 is implemented as the application processor of the mobile device 500, it should be understood that the system on-chip 510 may correspond to any semiconductor integrated chip that includes a central processing unit on which a dynamic voltage and frequency scaling is performed.

As described above, a display driving integrated circuit, a system including the display driving integrated circuit and a display driving method according to example embodiments may, in the fast display mode, reduce a data transfer path and data processing steps for generating the touch image corresponding to the touch operation of the user, and may enhance the touch response speed recognized by the user.

As will be appreciated by one skilled in the art, embodiments of the present disclosure may be embodied as a system, method, computer program product, or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain, or store a program for use by or in connection with an instruction execution system, apparatus, or device.

The present disclosure may be applied to an arbitrary electronic device or system that includes a touch panel and a display panel. For example, the present disclosure may be applied to electronic devices such as a memory card, a solid state drive (SSD), a computer, a laptop, a digital camera, a cellular phone, a smart-phone, a smart-pad, a personal digital assistants (PDA), a portable multimedia player (PMP), an MP3 player, a navigation system, a video camcorder, a portable game console, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A system comprising:
an input-output unit including a display panel configured to display images based on display data and a touch panel configured to provide touch data corresponding to a touch operation of a user;
a system on chip including a processor configured to generate graphic user interface (GUI) image data using a GUI engine;
a touch integrated circuit configured to generate touch coordinate data based on the touch data; and
a display driving integrated circuit configured to generate the display data based on the GUI image data provided from the processor in a normal display mode and configured to generate the display data based on the touch coordinate data provided from the touch integrated circuit in a fast display mode.

2. The system of claim 1, wherein the display driving integrated circuit is configured to, in the fast display mode, modify the display data based on the touch coordinate data.

3. The system of claim 1, wherein the processor is configured to monitor operations of the system and configured to generate a display mode signal indicating the normal display mode or the fast display mode.

4. The system of claim 1, wherein the fast display mode corresponds to an operation mode while the user writes or draws on the touch panel.

5. The system of claim 1, wherein, in the fast display mode, the touch coordinate data are transferred from the touch integrated circuit to the display driving integrated circuit through a direct transfer path connecting the touch integrated circuit and the display driving integrated circuit.

6. The system of claim 1, wherein, in the fast display mode, the touch coordinate data are transferred from the touch integrated circuit to the display driving integrated circuit through an internal transfer path within the system on chip.

7. The system of claim 1, wherein the display driving integrated circuit includes:
a frame memory configured to store the display data;
a driving unit configured to drive the display panel based on the display data stored in the frame memory;
a touch image generator configured to, in the fast display mode, generate modified display data representing a touch image corresponding to the touch operation of the user based on the display data stored in the frame memory and the touch coordinate data; and
a controller configured to control operations of the frame memory, the driving unit and the touch image generator.

8. The system of claim 7, wherein the controller is configured to update the display data by storing the GUI image data provided from the processor in the frame memory in the normal display mode and configured to update the display data by storing the modified display data provided from the touch image generator in the frame memory in the fast display mode.

9. The system of claim 7, wherein the display driving integrated circuit further includes a register configured to store set data of the touch image corresponding to the touch operation of the user.

10. The system of claim 9, wherein the touch image generator is configured to adjust at least one of a color and a width of the touch image based on the set data stored in the register.

11. The system of claim 1, wherein the display driving integrated circuit further includes:
a first interface for exchanging signals with the system on chip; and
a second interface for exchanging signals with the touch integrated circuit.

12. The system of claim 11, wherein, in the fast display mode, the touch coordinate data are transferred directly from the touch integrated circuit to the display driving integrated circuit through the second interface.

13. The system of claim 1, wherein the display driving integrated circuit further includes a first interface for exchanging signals with the system on chip, and
the system on chip further includes an internal transfer path that is enabled in the fast display mode.

14. The system of claim 13, wherein, in the fast display mode, the touch coordinate data are transferred from the touch integrated circuit to the system on chip and then transferred from the system on chip to the display driving integrated circuit through the internal transfer path and the first interface.

15. The system of claim 7, wherein the touch image generator includes:
a mapping unit configured to generate display coordinate data corresponding to the touch image based on the touch coordinate data and width information;
a synthesizer configured to generate the modified display data representing the touch image based on the display data stored in the frame memory, the display coordinate data and color information; and
a verification unit configured to compare the touch coordinate data with write region data representing a range of a write region on the touch panel to determine whether to generate the display coordinate data.

16. A display driving integrated circuit comprising:
a frame memory configured to store display data;
a driving unit configured to drive a display panel based on the display data stored in the frame memory;
a touch image generator configured to, in a fast display mode, generate modified display data representing a touch image corresponding to a touch operation of a user based on the display data stored in the frame memory and touch coordinate data; and
a controller configured to control operations of the frame memory, the driving unit and the touch image generator.

17. The display driving integrated circuit of claim 16, wherein the display driving circuit is configured to generate the display data based on graphic user interface (GUI) image data in a normal display mode and configured to generate the display data based on touch coordinate data in a fast display mode.

18. The display driving integrated circuit of claim 17, wherein the controller is configured to update the display data by storing the GUI image data in the frame memory in the normal display mode and configured to update the display data by storing the modified display data in the frame memory in the fast display mode.

19. A portable electronic device comprising:
a display panel configured to display images based on display data;
a touch panel configured to provide touch data;
a system on chip including a processor configured to generate graphic user interface (GUI) image data;
a touch integrated circuit configured to generate touch coordinate data based on the touch data;
a display driving integrated circuit configured to generate the display data based on a display mode; and
a memory device.

20. The portable electronic device of claim 19, wherein display driving integrated circuit configured to generate the display data based on the GUI image data in a normal display mode and configured to generate the display data based on the touch coordinate data in a fast display mode.
